(19) United States
(12) Patent Application Publication
(10) Pub. No.: US 2023/0204523 A1
(43) Pub. Date: Jun. 29, 2023

(54) RADIATION IMAGING APPARATUS AND RADIATION IMAGING SYSTEM

(71) Applicant: CANON KABUSHIKI KAISHA, Tokyo (JP)

(72) Inventor: Akehiko Uchiyama, Kanagawa (JP)

(21) Appl. No.: 18/059,116

(22) Filed: Nov. 28, 2022

(30) Foreign Application Priority Data
Dec. 23, 2021 (JP) 2021-209743

(51) Int. Cl. G01N 23/046; G01T 1/20; G01N 23/083

(52) U.S. Cl. CPC G01N 23/046; G01T 1/2018; G01N 23/083; G01N 2223/04; G01N 2223/40

(57) ABSTRACT

A radiation imaging apparatus comprises a readout unit and a gain map generation unit. The readout unit repetitively outputs the image data a plurality of times during a period in which radiation irradiation is performed for generating the gain map data. The gain map generation unit collects a plurality of image data output from the readout unit, and in response to stop of the radiation irradiation, generates the gain map data based on the plurality of image data except at least finally collected image data in the plurality of collected image data.

### BACKGROUND OF THE INVENTION

### Field of the Invention

The present invention relates to a radiation imaging apparatus and a radiation imaging system.

### Description of the Related Art

There exists a digital radiation imaging apparatus that irradiates an object with radiation from a radiation source and converts the intensity distribution of the radiation transmitted through an object into a digital signal by a solid-state imaging element, thereby obtaining an image.

An apparatus using, as imaging elements, a number of photoelectric conversion elements formed on a single-crystal silicon semiconductor wafer by a CMOS semiconductor manufacturing process is described in Japanese Patent Laid-Open No. 2002-026302. Also, an imaging element that stacks an amorphous silicon semiconductor on an insulating substrate is described in Japanese Patent Laid-Open No. 2008-259045.

In general, the operation characteristics of a plurality of photoelectric conversion elements arranged in imaging elements are not uniform, and, for example, sensitivity characteristics individually vary. Since an object image is modulated by the variation of sensitivity characteristic, this modulation needs to be removed to obtain the object image. The modulation for the object image is removed as in the following example. First, the output of each photoelectric conversion element in a uniform irradiation state without an object is held as digital data. This is called a gain map. Next, an object image is obtained, and the data of the output of each photoelectric conversion element is corrected using the gain map. Japanese Patent Laid-Open No. 2015-8884 describes obtaining sensitivity information from a gain calibration image without a moiré component in an X-ray image diagnosis apparatus including a grid swing mechanism.

In the radiation imaging apparatus, control for stably generating a specific amount of radiation is performed. For example, a tube current that decides the amount of X-rays in an X-ray tube is controlled by adjusting a filament current that heats a cathode filament. For this reason, it takes a while until the dose stabilizes after the start of X-ray irradiation.

During the period until the dose stabilizes after the start of irradiation by the X-ray tube, data output from the imaging element is preferably not used to generate the gain map. However, the time until the dose stabilizes is affected not only by the change of an operation parameter such as an irradiation dose but also by exhaustion of the cathode filament caused by evaporation or aging of the X-ray tube. It is therefore difficult to obtain the time needed for stabilization in advance.

Also, for the sake of safety, an X-ray generator is configured to stop irradiation as soon as the operator moves the hand off the irradiation switch. Hence, the dose is not stable near the end of irradiation. Data corresponding to this period is also preferably not used to generate the gain map.

### SUMMARY OF THE INVENTION

The present invention has been made in consideration of the above-described problem, and can provide a technique advantageous in generating a gain map to be used to correct an image in a radiation imaging apparatus.

According to the present invention, there is provided a radiation imaging apparatus comprising a radiation detector, a readout unit configured to read out a signal from the radiation detector and output image data corresponding to the signal, a gain correction unit configured to perform gain correction of the image data based gain map data, and a gain map generation unit configured to generate the gain map data, wherein during a period in which radiation irradiation is performed to generate the gain map data, the readout unit repetitively outputs the image data a plurality of times, and the gain map generation unit collects a plurality of image data output from the readout unit, and in response to stop of the radiation irradiation, generates the gain map data based on the plurality of image data except at least finally collected image data in the plurality of collected image data.

Further features of the present invention will become apparent from the following description of exemplary embodiments with reference to the attached drawings.

### BRIEF DESCRIPTION OF THE DRAWINGS

FIG. 1 shows the configuration of a radiation imaging system;

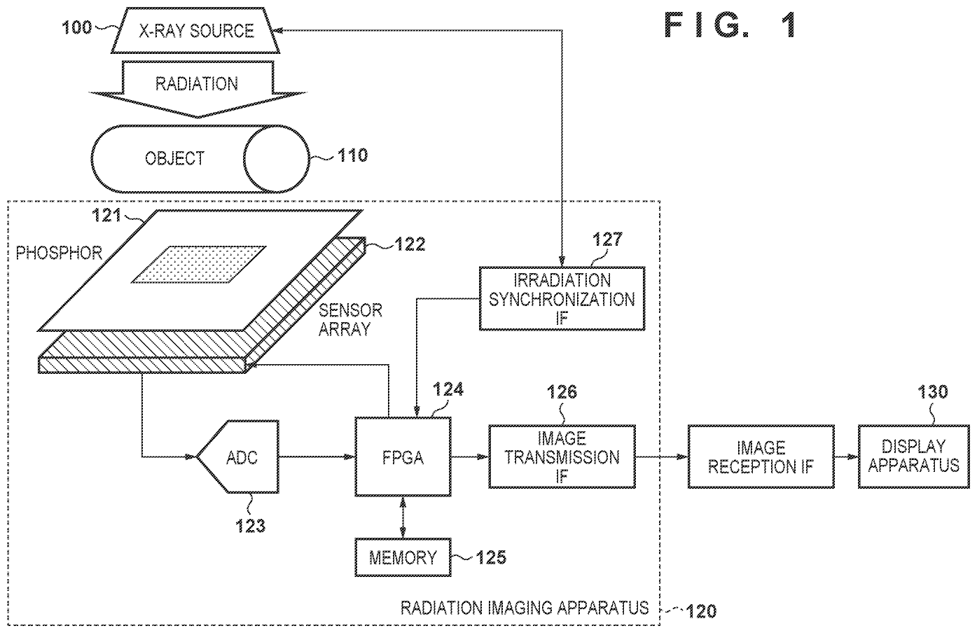

FIG. 2 is a view showing a data processing configuration;

FIGS. 3A and 3B show an image data collection operation;

FIGS. 4A to 4C show the temporal transition of contents of an image memory; and

FIG. 5 is an explanatory view of irradiation dose determination processing.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

In the present invention, radiation may include not only α-rays, (β-rays, γ-rays, and the like, which are beams generated by particles (including photons) emitted by radioactive decay but also beams having equal to or more than the energy of these beams, for example, X-rays, particle beams, and cosmic rays.

### First Embodiment

A radiation imaging system according to this embodiment will be described using X-ray imaging as an example of a radiation imaging apparatus. The radiation imaging system includes a radiation imaging apparatus 120 and an image display apparatus 130. These apparatuses are connected to each other via a communication interface. This system transmits, as an image signal, an image projected from an X-ray source 100 to the radiation imaging apparatus 120 through an object 110 to the display apparatus 130 and displays the image.

To perform imaging, the arrangement of each component is determined such that radiation from the X-ray source 100 is transmitted through the object 110 and projected to the radiation imaging apparatus 120. If radiation is emitted from the X-ray source 100 while synchronizing the operation timings of the radiation imaging apparatus 120 and the X-ray source 100 via an irradiation synchronization interface 127, the radiation is partially absorbed/shielded by the object 110 and enters a phosphor 121 of the radiation imaging apparatus 120. The phosphor 121 is a scintillator layer containing, for example, columnar crystal of cesium iodide (CsI) or the like, and emits light in accordance with the distribution of radiation that enters via the object 110.

A sensor array 122 is illustrated separately from the phosphor 121 for the descriptive convenience. In fact, the sensor array 122 can be stacked in tight contact with the phosphor 121. The distribution of light emission from the phosphor 121 is directly received by the sensor array 122. The sensor array 122 is, for example, a semiconductor sensor array including photoelectric conversion elements, and can function as a radiation detector together with the phosphor 121. Note that an element that directly converts radiation into an electrical signal may be employed as the radiation detector.

The sensor array 122 comprises a number of photoelectric conversion elements and a readout scan switch (not shown) configured to read out signals from the photoelectric conversion elements are arranged. The photoelectric conversion element generates an electrical signal according to the amount of light from the phosphor 121. The generated electrical signal is extracted to the outside in accordance with switching of the readout scan switch. Control such as a switching instruction for the scan switch can be done by a field programmable gate array (FPGA) 124 provided in the radiation imaging apparatus 120.

The electrical signal output from the sensor array 122 is converted into digital data by an analog/digital converter (ADC) 123. The digital data is processed by the FPGA 124. Thus, the FPGA 124 simultaneously performs control of the imaging apparatus and processing of the digital data from the sensor array 122. Correspondence between the received digital data and the position on the sensor array 122 can be obtained by simultaneously performing processing. By processing digital data in accordance with the correspondence between the digital data and the position on the sensor array 122, the FPGA 124 can form image data corresponding to the digital data and output it via an image transmission interface (IF) 126. The digital data thus output from the ADC 123 is image data corresponding to the digital data. For example, in moving image capturing, frame data can be created as image data in accordance with a frame rate. Also, the FPGA 124 can store the image data in a memory 125.

The image data processed by the FPGA 124 can be transmitted to the outside and displayed on the display apparatus 130. For example, if the above-described operation is repeated, the display apparatus 130 can display a moving image.

The digital data output from the ADC 123 does not always represents the shape of the object itself. This is because the sensitivity characteristics of the photoelectric conversion elements on the sensor array 122 are not uniform in some cases. It can be considered that the digital data obtained by the ADC 123 is obtained by multiplying the dose distribution by the sensitivity distribution of the photoelectric conversion elements and modulating the data. Hence, to restore the X-ray image of the object from the digital data from the ADC 123, the image needs to be corrected by performing conversion reverse to the process of the modulation, that is, division using a predetermined coefficient.

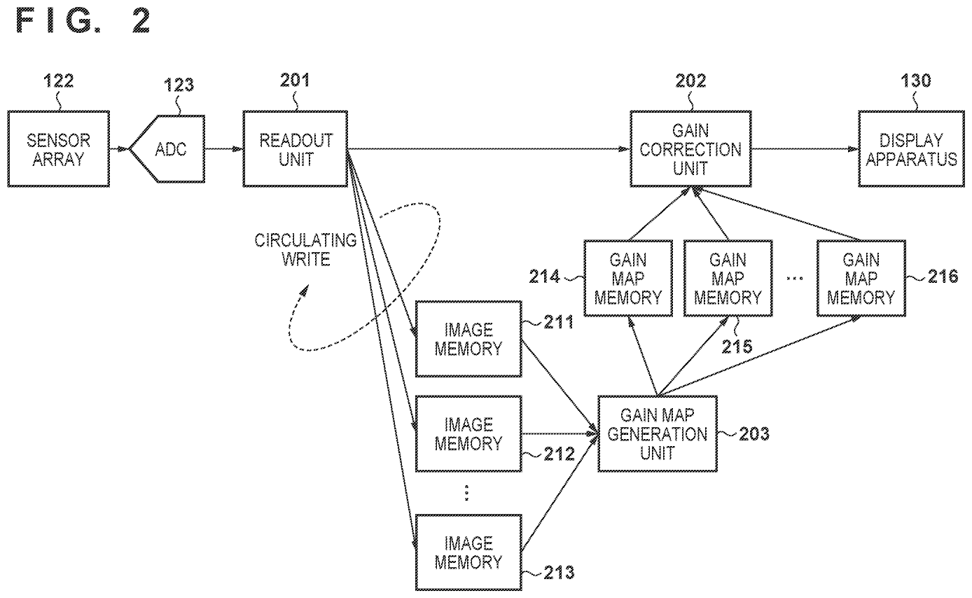

Processing of correcting the nonuniformity of the characteristic of the sensor array 122 will be described next with reference to FIG. 2. Correction processing can be implemented by the FPGA 124 and the memory 125. Here, image data corresponding to the sensitivity distribution of the photoelectric conversion elements from the sensor array 122 will be referred to as gain map data. Gain map data is stored in advance in a gain map memory 214 included in the memory 125. Digital data output from the ADC 123 after capturing the object 110 is processed by a readout unit 201, and sent to a gain correction unit 202 as image data corresponding to the digital data. Gain map data is created in correspondence with image data of a correction target.

The gain correction unit 202 reads out the gain map data from the gain map memory 214 in synchronism with the image data from the readout unit 201. By this operation, correction data corresponding to the coordinates of the image data is obtained from the gain map data. The value of each coordinate of the image data is divided by the value of a corresponding coordinate of the gain map data. This can obtain the X-ray image of the object for which modulation by the sensitivity distribution of the sensor array 122 is corrected.

The use method of the sensor array 122 sometimes changes depending on the purpose for which the radiation imaging system is used. In the radiation imaging apparatus that handles a moving image, operation parameters such as the frame rate and the irradiation dose are changed in accordance with the imaging target and the purpose. For example, if the frame rate changes, an accumulation period (light reception enable period) per frame changes. Alternatively, in accordance with required image quality, the dose is increased or decreased, or pixel binning or a signal amplification factor is changed.

Since the operation characteristic of the imaging element also changes according to this, a gain map data corresponding to image data can be acquired for each set of operation parameters. That is, a gain map data can be acquired while actually reproducing the frame rate and the irradiation dose and driving the radiation source and the imaging apparatus. Since the sensitivity distribution of the sensor array 122 changes in accordance with such operation parameters, gain map data needs to be prepared for each operation parameter. To implement this, in this embodiment, not only the gain map memory 214 but also the areas of gain map memories 215, . . . , 216 are provided in the memory 125, thereby holding a plurality of gain map data. At the time of correction, correction processing is performed while selecting the gain map memories 214, . . . , 216 in accordance with the change of the operation parameters. Note that the gain map data may be stored in a nonvolatile memory provided independently of the memory 125.

A method of generating gain map data will be described next. In this system, digital data obtained from the ADC 123 is generated by multiplying the dose distribution on the phosphor by the sensitivity distribution of the sensor array. Hence, in principle, digital data acquired in a state in which the dose distribution on the phosphor is kept uniform includes, as a component, the sensitivity distribution of the sensor array. Gain map data can be obtained based on the digital data obtained in this way.

However, digital data obtained while actually performing uniform irradiation is affected by elements other than the sensitivity distribution of the sensor array 122, for example, fluctuation of an X-ray quantum and thermal noise of an analog circuit. These are random events. Hence, after data is acquired a plurality of times, the influence may be reduced by statistical processing such as average calculation. To implement the plurality of times of data acquisition, areas of a plurality of image memories 211, 212, . . . , 213 are provided in the memory 125. Digital data output from the ADC 123 when uniform irradiation is converted into image data corresponding to the digital data by the readout unit 201. For example, the image data may correspond to the data of a frame of a moving image or may correspond to one still image.

The image data output from the readout unit 201 is stored in the image memory 211. Similarly, a plurality of image data are stored sequentially in the image memories 212, . . . , 213 while continuing irradiation. If a desired number of image data are obtained, a gain map generation unit 203 is activated to perform statistical processing such as averaging for the contents of the plurality of image memories 211, 212, . . . , 213, and the result is written in the gain map memory 214. Thus, gain map data in which the influence of random events is suppressed can be obtained.

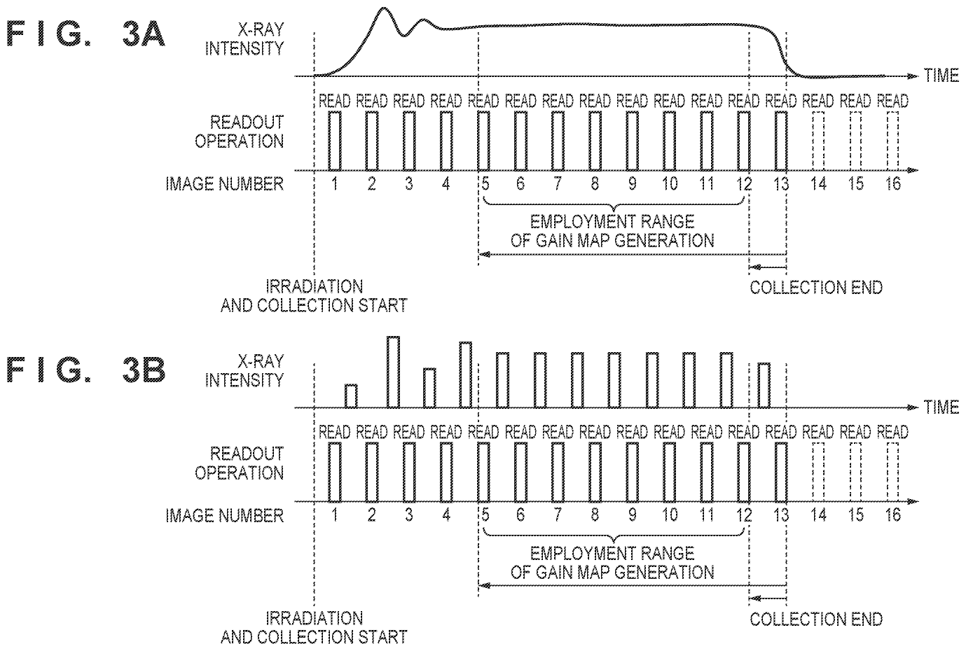

Generating gain map data in consideration of a variation in a time direction will be described next with reference to FIGS. 3A and 3B. If creation of gain map data is instructed, irradiation from the X-ray source is started in accordance with desired operation parameters, and collection of image data needed to generate a gain map is started in the radiation imaging apparatus 120.

At this time, irradiation with a uniform dose distribution on the phosphor is performed by not arranging an object. However, uniformity in the time direction cannot be guaranteed only by this. As shown in FIGS. 3A and 3B, the amount of X-rays (X-ray intensity) from the X-ray source is not stable at the early stage of irradiation, and time is taken until the amount can be regarded as constant. Even in the initial period of irradiation, readout of signals from the sensor array 122 is steadily repeated in accordance with the operation parameters, the ADC 123 outputs digital data, and the readout unit 201 repetitively outputs image data a plurality of times. The image data are continuously repetitively collected to the image memories 211, 212, . . . , 213 a plurality of times.

After control of X-ray irradiation stabilizes, the X-ray source 100 continues irradiation for not less than time necessary for generation of a gain map data and then stops irradiation. In response to the stop of irradiation, the radiation imaging apparatus 120 stops collecting data. In the series of operations, it is difficult to obtain, in advance, the period until the amount of X-rays becomes constant because this varies due to aging of the X-ray source 100 or the operation parameters.

However, that the amount of X-rays is stabilized as the result of control can be detected by, for example, monitoring the radiation dose. When generating the gain map, the X-ray source ensures a predetermined irradiation time not less than time to acquire a predetermined number of image data necessary for generation of a gain map after the irradiation stabilizes, then stops irradiation. This irradiation operation may be an automatic operation, or the operator may instruct to stop irradiation. In any method, if the radiation imaging apparatus is notified of the end of irradiation, the gain map generation operation is triggered.

In the series of operations, the amount of X-rays is not uniform at the early stage and the end of irradiation. Particularly at the early stage, it is difficult to know the period of nonuniformity in advance. On the other hand, nonuniformity at the end can occur if the end of irradiation and collection of image data do not synchronize. The possibility that nonuniformity at the end occurs is high if a human operation is interposed in the instruction to end irradiation. However, the nonuniformity at the end can fall within almost one frame. Hence, the range where data suitable for gain map generation exists in the digital data can be decided based on the point of time at which irradiation is ended, and collection is ended.

As shown in FIGS. 3A and 3B, a range between a point in time at which irradiation is stabilized and a point in time that is a predetermined amount of time prior to when irradiation ends is decided as the employment range of gain map generation data. Gain map generation processing is executed based on a predetermined number of image data included in this range, thereby obtaining stable gain map data.

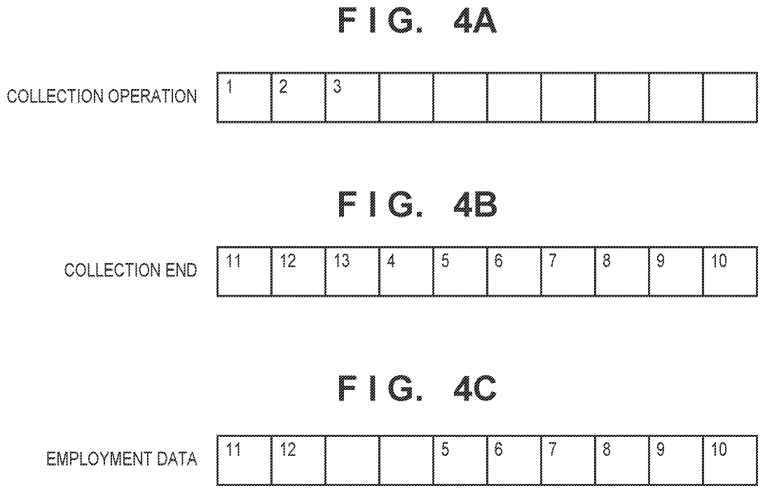

A procedure of extracting data in a range suitable for a gain map from a plurality of digital data will be described with reference to FIGS. 4A to 4C. Here, for the descriptive convenience, the number of image data storable in the memory is set to 10 as an example of the range.

In this example, (1) finally collected image data (this will be referred to as “first retroactive data”) is not employed, and (2) eight image data before the finally collected image data, which include the second to ninth retroactive image data, are employed as original data used to generate a gain map. Here, for the descriptive convenience, the number of image data used to generate a gain map is 8.

Rectangles shown in FIGS. 4A to 4C each represent a memory capable of storing one image data and correspond to the image memories 211, 212, . . . , 213. FIGS. 4A to 4C show that image memories for 10 image data are prepared. This number is larger than the number of memories for storing a predetermined number of image data used to generate a gain map. Thus, the capacity of image memories is set to store image data more than the predetermined number of image data used to generate a gain map. If X-ray irradiation and data collection are started, image data are stored one by one in the image memories each represented by one rectangle sequentially from the first memory. FIG. 4A shows a state in which the first three image data are stored. The number in each rectangle corresponds to the image number in FIG. 3. From then on, collected image are stored in a similar manner.

In this example, when image data of image number 10 is stored, all image memories are filled. If the capacity of image memories runs short, image data is stored while circulating through the memories such that the memory storing image data of the smallest image number is overwritten. FIG. 4B shows the state of the memories at the point of time when image data up to the 13th image data are stored. The first three data have been disappeared. The first, second, and third image data are overwritten by the 11th, 12th, and 13th image data and disappear. Since collection stops here, 14th and subsequent image data are not stored in the image memories.

In the memory storage, the data is sequentially overwritten in chronological order. Hence, of the collected data, latest 10 image data remain on the memories. In this example, eight image data suffice for gain map creation. That is, as the employment range of image data for creation, “ninth retroactive data” and subsequent image data suffice. It is therefore obvious that a predetermined number of data can be obtained from the remaining data.

FIG. 4C shows a state in which data is limited in the employment range. The 13th image data that is the “first retroactive data” is removed, and eight temporal retroactive image data, fifth to 12th image data, are employed. Note that for the descriptive convenience, unemployed image data are not illustrated. As an actual operation, the unemployed image data need not be erased from the memories, and these are simply not readout in the gain map generation processing.

When, of the data stored in the image memories 211, 212, . . . , 213, the data in the employment range are decided, the gain map generation unit 203 is activated. In the activation, a setting may be done such that, of the image memories 211, 212, . . . , 213, the numbers of image memories in the employment range are designated, and the remaining image memories are not read-accessed. The result of gain map data generation processing is stored in the gain map memory 214 and can be used from the gain correction unit 202.

In the above description, the number of image data with which collection is stopped is 13. As described above, since the nonuniformity period at the early stage of irradiation cannot be predicted, the total length of collection may also change every time the processing is executed, and the number at which collection is stopped can also vary. However, regardless of the timing at which collection is ended, a predetermined number of image data within the necessary range can be obtained by appropriately setting the capacity of memories, as is apparent from the principle of the operation of storing data while circulating through the memories.

In the above description, gain map data corresponding to a certain set of operation parameters is obtained on the gain map memory 214. If the operation parameters change in accordance with the use purpose of the imaging apparatus, another gain map data is needed. To obtain this, the operation parameters are set again in both the X-ray source and the imaging apparatus, and image data collection is repeated by performing uniform irradiation. The storage destination of the generated gain map data may be changed on an operation parameter basis. For example, gain map data obtained with the first operation parameter is stored in the gain map memory 214, and gain map data obtained with the second operation parameter is stored in the gain map memory 215.

### Second Embodiment

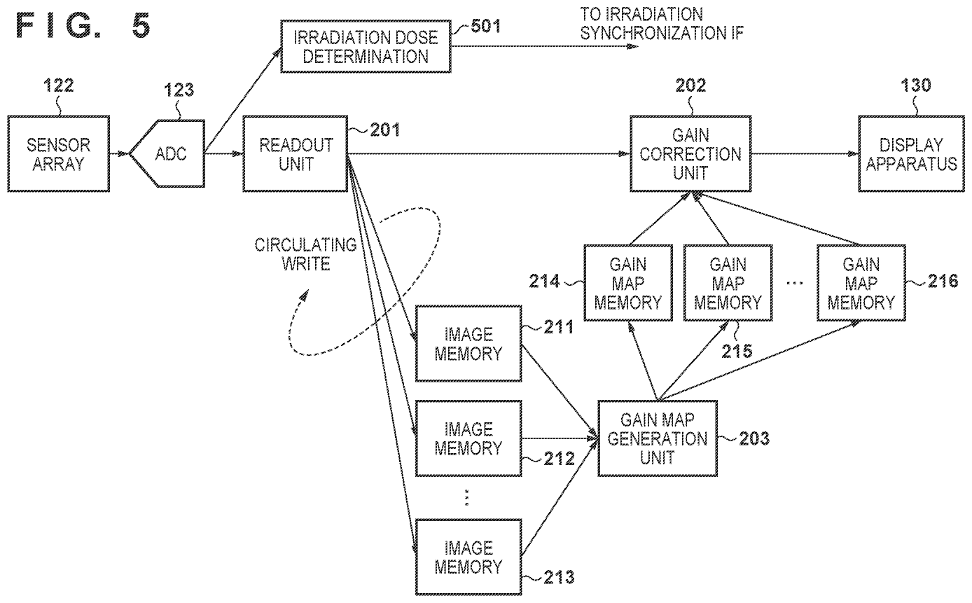

A configuration in which a radiation imaging apparatus leads the stop of image data collection will be described next with reference to FIG. 5. In this embodiment, an irradiation dose determination unit 501 that determines the stability of X-ray irradiation by monitoring the output of an ADC 123 is added.

A description about, when acquiring gain map data, performing uniform irradiation while synchronizing an X-ray source 100 and a radiation imaging apparatus 120 and collecting image data to image memories will be omitted. In this embodiment, in parallel to image data collection, the irradiation dose determination unit 501 monitors time transition of the output of the ADC 123 and determines whether initial control of X-ray irradiation is stabilized. The stability can be judged by monitoring whether a plurality of temporally continuously output digital data fall within a predetermined deviation.

After it is confirmed that irradiation is stabilized, whether data collection to the image memories progresses while maintaining the stability of irradiation is monitored. If image data more than a predetermined number of data necessary for gain map generation are collected to the image memories while maintaining the stability of irradiation, the irradiation dose determination unit 501 stops image data collection. Also, the irradiation dose determination unit 501 notifies, via an irradiation synchronization interface, the X-ray source that irradiation is not necessary any more. In response to the irradiation stop notification, the X-ray source stops irradiation or makes display to urge the operator to stop irradiation.

In this embodiment, the stability of irradiation is determined based on X-rays that have actually reached the radiation imaging apparatus. If this determination is performed by the radiation imaging apparatus, for example, gain map data that outputs the existence of an unintended object can be prevented from being generated.

The embodiments of the present invention have been described above, but the present invention is not limited to these embodiments, as a matter of course. For example, FIG. 3A shows the waveform of X-rays as a continuous curve. However, X-ray irradiation need not be continuous. For example, as shown in FIG. 3B, pulse irradiation synchronized with the sensor array may be performed in accordance with an instruction to start gain map data acquisition, and image data may be collected until an instruction to end the acquisition.

As the memory, a DDR-DRAM, a flash memory, or the like can be used. A memory of any operation principle can be used if it can hold data for gain map generation and correction processing.

Also, in the description, the image memories and the gain map memories are arranged in areas of the memory 125. However, image data and gain map data may be stored in physically separated independent memories. Also, in the above description, the capacity of the image memories corresponds to 10 image data, and the amount of image data used to generate a gain map corresponds to eight image data. These capacities may also appropriately be changed. For example, to simplify average calculation, the number of image data may be an integer power of 2. To ensure image data sufficient for suppressing a random component, 16 or 32 image data are used. If unemployed image data at the end of collected data are added to this, the capacity of image memories corresponds to 17 or 33 image data. The number of unemployed image data at the end of collected data is not limited to one, and, for example, three image data as much as the uncertainty at the end of collection may be added. In this case, the necessary capacity of image memories corresponds to 19 or 35 image data. The capacity may be configured to be changeable in accordance with the operation parameters of the imaging apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No.2021-209743 filed Dec. 23, 2021, which is hereby incorporated by reference herein in their entirety.

What is claimed is:

1. A radiation imaging apparatus comprising: a radiation detector; a readout unit configured to read out a signal from the radiation detector and output image data corresponding to the signal; a gain correction unit configured to perform gain correction of the image data based gain map data; and a gain map generation unit configured to generate the gain map data, wherein
during a period in which radiation irradiation is performed to generate the gain map data, the readout unit repetitively outputs the image data a plurality of times, and
the gain map generation unit collects a plurality of image data output from the readout unit, and in response to stop of the radiation irradiation, generates the gain map data based on the plurality of image data except at least finally collected image data in the plurality of collected image data.

2. The apparatus according to claim 1, wherein the plurality of image data are a predetermined number of image data collected before the excluded image data.

3. The apparatus according to claim 2, further comprising a memory having a capacity for storing the image data in a number larger than the predetermined number,
wherein the gain map generation unit stores the image data in the memory.

4. The apparatus according to claim 3, wherein in the storage of the image data, if the capacity of the memory runs short, image data that is newly read out is sequentially overwritten on image data that is stored temporally earliest.

5. The apparatus according to claim 3, wherein when capturing a moving image, the capacity of the memory corresponds to not less than 10 to 33 frames.

6. The apparatus according to claim 3, wherein the gain map generation unit stops storing the image data in the memory in response to the stop of the radiation irradiation.

7. The apparatus according to claim 3, further comprising an irradiation dose determination unit, the irradiation dose determination unit determining whether a plurality of temporally continuous signals from the radiation detector fall within a predetermined deviation,
wherein if the image data collected after it is determined by the irradiation dose determination unit that the signals fall within the predetermined deviation are stored, in the memory, in a number larger than the predetermined number, the gain map generation unit generates a signal for instructing the stop of the radiation irradiation.

8. The apparatus according to claim 1, wherein the gain map data is generated for each operation parameter that is set when capturing radiation, and stored in a gain map memory.

9. A radiation imaging system comprising:
a radiation source configured to perform radiation irradiation; and
a radiation imaging apparatus defined in claim 1.
